(19) United States
(12) Patent Application Publication
(10) Pub. No.: US 2004/0202872 A1
(43) Pub. Date: Oct. 14, 2004

(54) Hydrophobic surface treatment composition and method of making and using same

(75) Inventors: Jiafu Fang, Spring, TX (US); Roderic Mathews, The Woodlands, TX (US); Marlene Storzer, The Woodlands, TX (US)

Correspondence Address: JENKENS & GILCHRIST, 1401 MCKINNEY, SUITE 2600, HOUSTON, TX, 77010, US

(73) Assignee: Pennzoil-Quaker State Company

(21) Appl. No.: 10/625,362

(22) Filed: Jul. 23, 2003

Related U.S. Application Data
(60) Provisional application No. 60/398,069, filed on Jul. 23, 2002.

(51) Int. Cl. B32B 25/20

(52) U.S. Cl. 428/447

(57) ABSTRACT

A treated article including a substrate and a hydrophobic film coated to the surface of the substrate. The film is obtainable from a hydrophobic surface treatment composition comprising a mixture or reaction product of a silicone fluid and a solvent. The silicone fluid is an alkyl silane or a polysiloxane having a functional group capable of a condensation reaction with hydroxyl. The hydrophobic surface treatment composition is substantially free of an external curing agent. The hydrophobic surface treatment composition may contain a cosolvent or catalyst. A method of manufacturing the treated article is also disclosed.

### CROSS REFERENCE TO RELATED APPLICATIONS

This patent application claims priority to U.S. Provisional Application Serial No. 60/398,069, filed on Jul. 23, 2002, entitled “Hydrophobic Surface Treatment Compositions and Method of Making and Using the Same,” which is incorporated by reference herein in its entirety.

### FEDERALLY SPONSORED RESEARCH

Not applicable.

### REFERENCE TO MICROFICHE APPENDIX

Not applicable.

### FIELD OF THE INVENTION

The invention is directed to the field of hydrophobic surface treatment compositions and articles made therefrom, including optical component lenses and windows or windshields for automobiles, aircraft, ships, and buildings.

### BACKGROUND OF THE INVENTION

Protective coatings capable of imparting high hydrophobicity to a variety of substrates are desirable to reduce exposure or deterioration of the surface. One source of deterioration is moisture. A highly hydrophobic coating may protect the surface by causing water to bead rather than penetrating into the substrate. Beading may also be desirable for aesthetic reasons.

Protective coatings typically take the form of water repellent compositions that are applied to a surface of the substrate in liquid form and then allowed to cure. These coatings are typically applied to the surface of the substrate in relatively thick films to form a substantial physical barrier between the environment and the substrate surface. In some instances coatings are colored or colorless depending on the need to preserve the underlying aesthetic features of the substrate. For example, when using a protective coating to protect a wood surface, it is desirable that the coating be clear to preserve the aesthetic features of the wood surface.

Protective coatings are also needed to protect substrates other than those mentioned above. For instance, protective coatings may be desired to protect the surface of objects made from plastic or glass from harmful effects of weather, heat and chemicals. Depending on the particular object or function of objects made from such materials, certain protective coatings may not be well suited for providing the desired protection of such materials.

Plastic or glass is typically chosen due to a particular aesthetic or functional purpose. For example, glass or plastic materials are commonly used to make windows for homes, buildings, automobiles, or airplanes and the like. Windows are typically installed to separate an indoor environment from an outdoor environment while preserving the ability to view one environment from the other. Accordingly, at least one surface of the window is exposed to elements that are known to cause weather damage and deterioration. Hydrophobic coatings allow water drops to bead, thereby facilitating their movement across a window when a force such as air pressure is applied.

Coatings for plastic materials are desirable since plastic is more susceptible to deterioration due to exposure to moisture. Exposure to moisture, whether by accumulation on the surface due to rain, or by other direct contact with water, makes viewing objects through the surface difficult when haziness or other visual distortion occurs.

Accordingly, there is a need for coatings that do not require further use of an external curing agent to protect the surface of glass, clear plastic or other material susceptible to damage by weather, heat, chemicals, or other factors, that undesirably interact with the surface in the presence of water would be useful. Also, protective coatings that are durable and substantially retain their protective properties when immersed in water or abraded for long periods of time would also be desirable.

### SUMMARY OF THE INVENTION

The above need is fulfilled by various aspects of the invention. In one aspect, a hydrophobic surface treatment composition is applied to a substrate to form a treated article. In another embodiment, a method of manufacturing a treated surface includes applying a hydrophobic surface treatment composition to a substrate having hydroxyl groups on at least one surface and allowing the composition to dry. The hydrophobic surface treatment composition for both embodiments is a mixture or reaction product of a silicone fluid and a solvent. The silicone fluid is an alkyl silane or a polysiloxane having a functional group capable of a condensation reaction with hydroxyl. In certain embodiments, the functional group is an alkoxy, a hydroxy or an amino group. In alternate embodiments, the hydrophobic surface treatment composition may further include a catalyst or cosolvent. In some embodiments, the hydrophobic surface treatment composition is substantially free of external curing agents. In some embodiments, the treated surface has a contact angle greater than about 80°. In certain embodiments, the composition is allowed to dry by evaporation at ambient temperatures. In other embodiments, the composition is allowed to dry by heating.

### BRIEF DESCRIPTION OF THE DRAWINGS

FIG. 1 is a graphical representation of contact angle as a function of wiper cycles.

### DESCRIPTION OF EMBODIMENTS OF THE INVENTION

In the following description, all numbers disclosed herein are approximate values, regardless whether the word “about” or “approximately” is used in connection therewith. They may vary by up to 1%, 2%, 5%, or sometimes 10 to 20%. Whenever a numerical range with a lower limit, R_{L}, and an upper limit R_{U}, is disclosed, any number R falling within the range is specifically disclosed. In particular, the following numbers R within the range are specifically disclosed: R=R_{L}+k*(R_{U}−R_{L}), wherein k is a variable ranging from 1% to 100% with a 1% increment, (i.e., k is 1%, 2%, 3%, 4%, 5%, . . . , 50%, 51%, 52%, . . . , 95%, 96%, 97%, 98%, 99%, or 100%). Moreover, any numerical range defined by two numbers, R, as defined in the above is also specifically disclosed.

Disclosed herein are hydrophobic surface treatment compositions and hydrophobic articles made from such compositions. The hydrophobic surface treatment composition comprises a mixture or reaction product of a silicone fluid and a solvent. Some embodiments include a cosolvent or a catalyst or both a cosolvent and a catalyst in the hydrophobic surface treatment composition. Articles that employ such hydrophobic surface treatments include, for example, glass and plastic windows, metal and wood. Methods of making such compositions and articles are also described. In some embodiments, the hydrophobic surface treatment composition is substantially free of an external curing agent.

As used herein, the term “substantially free of an external curing agent” means that the hydrophobic surface treatment compositions contains less than about 5 wt. % of an external curing agent. In some embodiments, “substantially free” means less than 3 wt. %, less than 1 wt %, or less than 0.5 wt %.

In some embodiments, the hydrophobic surface treatment composition is applied to a substrate which has hydroxyl groups or hydrolyzable groups on at least one surface. Suitable substrates include glass, metal, wood, or polymers. Preferably, the substrate is a windshield of an automobile, airplane, or other vehicle.

The hydrophobic surface treatment composition herein is a mixture or reaction product of a silicone fluid, a solvent, a cosolvent, and a catalyst. Suitable silicone fluids include, but are not limited to, polysiloxanes, alkyl silane fluids, or combinations thereof. Any silicone fluid which includes a functional group capable of a condensation reaction with hydroxyl or hydrolyzable groups may be used. The condensation reaction between the hydrophobic surface treatment composition and the substrate may result in a covalent bond between the composition and the substrate.

Preferably, the polysiloxane follows the formula:

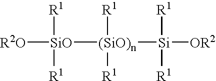

wherein each R¹ and R² is individually selected from the group consisting of hydrogen and substituted or unsubstituted, saturated or unsaturated, alkyl or aryl hydrocarbyl groups having 1 to 40 carbon atoms, and wherein n ranges from greater than 0 to about 150. All R¹ need not be the same. All R² need not be the same. At least one R¹ or R² is not hydrogen. Some preferred hydrocarbyl groups include methyl, ethyl, propyl, vinyl allyl, and phenyl groups. Other suitable hydrocarbyl groups contain a hydrolyzable functional group. Such hydrolyzable functional groups include alkoxy group or ester derivative groups having 1-40 carbon atoms, such as, for example, methoxy ethoxy groups. Additionally, some hydrocarbyl groups are substituted with a fluoride, chloride, bromide, and iodide. In a preferred embodiment, the polysiloxane is a poly dialkyl siloxane, such as polydimethylsiloxane. In a preferred embodiment, R¹ or R² is an alkoxy, hydroxy or amino functionalized group.

In some embodiments, at least one R² of the polysiloxane is an amino functionalized hydrocarbyl group. Amino functionalized hydrocarbyl groups may have from 1 to about 40 carbon atoms. One particular amino-functionalized hydrocarbyl group is a 1-amino propyl group. However, the amino functionality need not be a primary amine, for instance, a 2-amino propyl group is also suitable. Another suitable amino-functionalized hydrocarbyl group is the ethyl amino propyl (CH₂CH₂CH₂NHCH₂CH₂NH₂) group. Other suitable amino-functionalized hydrocarbyl groups may include other functional groups or may include substituted amino groups such as —CH₂CH₂(NHR³)CH₂CH₃ where R³ is any alkyl or aryl group having from 1-40 carbon atoms. The amino functionality of the silicone fluids discussed above, may be reacted with numerous other chemical moieties designed to improve the hydrophobicity and durability of the coating formed from the hydrophobic surface treatment composition. Examples of such compounds include, but are not limited to, for example, long-chain epoxides, isocyanates, and fatty acid derivatives that react with the amino-substituted silicones at appropriate base-equivalent ratios. Manufacturing of such compounds is straightforward and permits the preparation of a wide variety of polysilicones tailored to suit particular purposes. Methods of manufacturing such compounds include, but are not limited to, those disclosed in U.S. Pat. Nos. 6,472,4; 686,482,912; and 6,576,734 all of which are hereby incorporated by reference in their entirety.

Suitable polysiloxanes include, but are not limited to, a linear, branched or cyclic polydimethylsiloxane; polysiloxanes having a hydroxyl group in the molecular chain such as silanol-terminated polydimethylsiloxane, silanol-terminated polydiphenylsiloxane, diphenylsilanol-terminated polydimethylphenylsiloxane, carbinol-terminated polydimethylsiloxane, hydroxypropyl-terminated polydimethylsiloxane and polydimethyl-hydroxyalkylene oxide methylsiloxane; polysiloxanes having an amino group in the molecular chain such as bis (aminopropyldimethyl)siloxane, aminopropyl-terminated polydimethylsiloxane, aminoalkyl group-containing, T-structured polydimethylsiloxane, dimethylamino-terminated polydimethylsiloxane and bis(aminopropyldimethyl)siloxane; polysiloxanes having a glycidoxyalkyl group in the molecular chain such as glycidoxypropyl-terminated polydimethylsiloxane, glycidoxypropyl-containing, T-structured polydimethylsiloxane, polyglycidoxypropylmethylsiloxane and a polyglycidoxypropylmethyldimethylsiloxane copolymer; polysiloxanes having a chlorine atom in the molecular chain such as chloromethyl-terminated polydimethylsiloxane, chloropropyl-terminated polydimethylsiloxane, polydimethyl-chloropropylmethylsiloxane, chloro-terminated polydimethylsiloxane and 1,3-bis (chloromethyl)tetramethyldisiloxane; polysiloxanes having a methacryloxyalkyl group in the molecular chain such as methacryloxypropyl-terminated polydimethylsiloxane, methacryloxypropyl-containing, T-structured polydimethylsiloxane and polydimethyl-methacryloxypropylmethylsiloxane; polysiloxanes having a mercaptoalkyl group in the molecular chain such as mercaptopropyl-terminated polydimethylsiloxane, polymercaptopropylmethylsiloxane and mercaptopropyl-containing, T-structured polydimethylsiloxane; polysiloxanes having an alkoxy group in the molecular chain such as ethoxy-terminated polydimethylsiloxane, polydimethylsiloxane having trimethoxysilyl on one terminal and a polydimethyloctyloxymethylsiloxane copolymer; polysiloxanes having a carboxyalkyl group in the molecular chain such as carboxylpropyl-terminated polydimethylsiloxane, carboxylpropyl-containing, T-structured polydimethylsiloxane and carboxylpropyl-terminated, T-structured polydimethylsiloxane; polysiloxanes having a vinyl group in the molecular chain such as vinyl-terminated polydimethylsiloxane, tetramethyldivinyldisiloxane, methylphenylvinyl-terminated polydimethylsiloxane, a vinyl-terminated polydimethyl-polyphenylsiloxane copolymer, a vinyl-terminated polydimethyl-polydiphenylsiloxane copolymer, a polydimethyl-polymethylvinylsiloxane copolymer, methyldivinyl-terminated polydimethylsiloxane, a vinyl terminated polydimethylmethylvinylsiloxane copolymer, vinyl-containing, T-structured polydimethylsiloxane, vinyl-terminated polymethylphenetylsiloxane and cyclic vinylmethylsiloxane; polysiloxanes having a phenyl group in the molecular chain such as a polydimethyl-diphenylsiloxane copolymer, a polydimethyl-phenylmethylsiloxane copolymer, polymethylphenylsiloxane, a polymethylphenyl-diphenylsiloxane copolymer, a polydimethylsiloxane-trimethylsiloxane copolymer, a polydimethyl-tetrachlorophenylsiloxane copolymer and tetraphenyldimethylsiloxane; polysiloxanes having a cyanoalkyl group in the molecular chain such as polybis(cyanopropyl)siloxane, polycyanopropylmethylsiloxane, a polycyanopropyl-dimethylsiloxane copolymer and a polycyanopropylmethyl-methyphenylsiloxane copolymer; polysiloxanes having a long-chain alkyl group in the molecular chain such as polymethylethylsiloxane, polymethyloctylsiloxane, polymethyloctadecylsiloxane, a polymethyldecyl-diphenylsiloxane copolymer and a polymethylphenetylsiloxane-methylhexylsiloxane copolymer; polysiloxanes having a fluoroalkyl group in the molecular chain such as polymethyl-3,3,3-trifluoropropylsiloxane and polymethyl-1,1,2,2-tetrahydrofluorooctylsiloxane; polysiloxanes having a hydrogen atom in the molecular chain such as hydrogen-terminated polydimethylsiloxane, polymethylhydrosiloxane and tetramethyldisiloxane; hexamethyldisiloxane; and a polydimethylsiloxane-alkylene oxide copolymer. Many polysiloxanes are commercially available as water repellents, such as Super Rain X formed mainly of polydimethylsiloxane (supplied by Unelko) and Glass Clad 6C formed mainly of polydimethylsiloxane whose terminal groups are replaced with chlorine atom (supplied by Petrarch Systems Inc.). The above polysiloxanes may be used alone or in combination. Other suitable polysiloxanes are those organic polysiloxanes disclosed in U.S. Pat. No. 5,939,491, which is hereby incorporated by reference. The curing agents of U.S. Pat. No. 5,939,491 are not necessary for the hydrophobic surface treatment composition disclosed herein.

Some silicone fluids useful herein have a viscosity at 25° C. ranging from about 1 to about 100,000 cps. Other silicone fluids may have a viscosity outside this range. In some preferred embodiments, the silicone fluid has a viscosity of about 2 to about 50,000 cps. Some other suitable silicone fluids have a viscosity at 25° C. ranging from about 5 to about 10,000 cps. In still other embodiments, the silicone fluid has a viscosity of about 25, about 50, about 100, or about 500 cps. Fluids with a viscosity of about 1000, about 2000, about 5000, or about 7500 cps are also suitable.

Suitable alkyl silanes are represented by the following general formula:

R¹ₐSiX₍₄₋ₐ₎

where R¹ is a monovalent hydrocarbon group having 3 to 20 carbon atoms. The following are specific examples of such groups: a propyl group, n-butyl group, pentyl group, n-decyl group, or a similar alkyl group; a cyclohexyl group, or a similar cycloalkyl group. X in the above formula is a hydrolyzable group, preferably a methoxy group, ethoxy group, propoxy group, or a similar alkoxy group. However, X may also be a phenoxy group, a ketooxime group, or an isopropenoxy group. In the above formula, a is an integer having a value of 1 to 3, 1 being preferable. The following are examples of the aforementioned organosilane component, but are not limited to: n-butyltrimethoxysilane, n-decyltrimethoxysilane, isobutyltrimethoxysilane, n-hexyltrimethoxysilane, and cyclohexylmethyldimethoxysilane. Alkyl silanes of the aforementioned type may be used separately or in a mixture of two or more.

Generally, the silicone fluid is mixed with a solvent. Preferably, the solvent is miscible with the silicone fluid. Suitable solvents include, but are not limited to, alkyl or aryl, substituted or unsubstituted alcohols, ethers, esters, or hydrocarbons having between 1 and 40 carbon atoms. In some embodiments the solvent is water. Other solvents have a boiling point ranging from about 100° F. to about 400° F. Preferably, the solvent has a boiling point ranging from about 150° F. to about 350° F. However, any solvent that is miscible with the employed silicone fluid may be used.

Some suitable alcohols for use as the solvent include, but are not limited to, methanol, ethanol, isopropanol, or isobutanol. In some other embodiments, the solvent is 1-propanol, 2-propanol, 1-butanol, 2-butanol, 3-butanol, tert-butyl alcohol, a methyl butanol, a dimethyl butanol, 1-propanol, 2-propanol, 3-propanol, cyclohexanol, phenol, tert-butyl phenol, 2-ethylhexanol, 2-ethoxyethanol, 1-dodecanol, or mixtures thereof.

In some embodiments, the solvent is an ethylene glycol derivative such as, for example, ethylene glycol, ethylene glycol monobutyl ether and ethylene glycol acetate monoethyl ether, diethylene glycol derivatives such as diethylene glycol and diethylene glycol monobutyl ether, and diacetone alcohol or the like. In some embodiments, the solvent is toluene, xylene, ethyl acetate, butyl acetate, methyl ethyl ketone, methyl isobutyl ketone, methyl ethyl ketoxime or the like may be used in combination of these solvents. One suitable solvent is a (mono) propylene glycol tertiary butyl ether commercially available as ARCOSOLV® PTB, CAS No. 57018-52-7. Another suitable solvent is propoxy propanol, commercially available as ARCOSOLV® PNP from Lyondell Chemical Company.

While any hydrocarbon solvent may be used, particular embodiments employ mineral spirits as the solvent. In other embodiments, the hydrocarbon solvent is an isoparaffin solvent, such as ISOPAR™ solvents available from the Exxon Chemical Company.

The amount of solvent used in preparing compositions can vary. Generally, the amount of solvent used ranges from about 0.5 percent by weight of the composition to about less than 100 percent by weight of the composition. In some embodiments, the solvent comprises about 99.5 percent by weight, about 95 percent by weight, about 90 percent by weight, about 75 percent by weight, or about 50 percent by weight of the composition. In other embodiments, the solvent comprises about 40 percent by weight, about 30 percent by weight, or about 20 percent by weight. In still other embodiments, the solvent comprises about 70 percent by weight to about 85 percent by weight or from about 80 to about 95 percent by weight of the composition. In still other embodiments, the solvent may comprise a smaller or larger fraction of the total composition.

In those embodiments where a cosolvent is used, it may be present in any convenient amount. If desired, a cosolvent may optionally be used. Suitable cosolvents include those compounds described herein as solvents, namely, alkyl or aryl, substituted or unsubstituted alcohols, ethers, esters, or hydrocarbons having between 1 and 40 carbon atoms and water, but are not limited to them. Typically, in those embodiments where a cosolvent is employed, it will be present in an amount less than the solvent. However, in some embodiments the cosolvent may be present in an amount greater than the solvent. In some embodiments, the cosolvent comprises from greater than 0 percent by weight to about 50 percent by weight of the hydrophobic film composition. In some embodiments, the cosolvent preferably comprises from greater than 0 percent by weight to about 20 percent by weight of the hydrophobic film composition. In other embodiments, the cosolvent comprises from greater than about 1 percent by weight to about 15 percent by weight or from greater than 2 percent by weight to about 10 percent by weight of the hydrophobic film composition.

A catalyst may optionally be used in some embodiments. The catalyst preferably lowers the activation energy of the reaction between the functional groups of the silicone fluid and the hydroxyl groups on the substrate so that the reaction can occur at ambient temperatures. The catalyst may be a chemical compound or a physical phenomenon such as heat or one or more light frequencies that cause the catalyst to react in the presence of any of the other components of the composition. Typically, a catalyst is employed in those embodiments where the silicone fluid is a polysiloxane, especially alkoxy-substituted polysiloxanes. In some embodiments, the catalyst is an acid or a metal salt of an organic acid. Typically, suitable acids are provided as a solution having a pH below about 6.5. However, solutions of acids have a pH below about 5.0, about 4.0, or about 3.0 may also be used. Other suitable acid solutions may have a lower pH. In other embodiments, the acid may not be in solution form. Some preferred acids include, but are not limited to, acetic acid, sulfuric acid, nitric acid, phosphoric acid, and hydrochloric acid. In embodiments where the catalyst is a metal salt of an organic acid, the metal may be any element of Groups IIB, IIIB, IVB, IIIA, and IVA of the Periodic Table of Elements.

The amount of catalyst typically ranges from greater than 0 percent by weight to about 10 percent by weight of the hydrophobic film composition, although amounts outside this range may also be used. Preferably, the catalyst comprises from greater than 0 percent by weight to about 5 percent by weight of the hydrophobic film composition, or about 0.5 percent by weight to about 1 or about 2 percent by weight of the hydrophobic film composition.

In addition to the foregoing components, the hydrophobic surface treatment compositions may include one or more optional ingredients such as plasticizers, anti-oxidants, light stabilizers, mildewcides and fungicides, surfactants and flow control additives as are well known in the art.

As mentioned above, the hydrophobic surface treatment composition in some embodiments is substantially free or completely free of any external curing components capable of condensation reactions with the functional groups of the silicone fluid. Examples of such curing agents include, but are not limited to, aminoplast resins and phenoplast resins and mixtures thereof, polyisocyanates and blocked polyisocyanates, anhydrides, polyepoxides, polyacids, polyols, and polyamines. These agents are more fully described in U.S. Pat. Nos. 3,919,315; 3,919,351; 4,046,729; 4,681,811; 4,732,790; 4,798,746 and 5,468,802, all of which are hereby incorporated by reference.

The components are generally mixed together in any order for forming the composition. In some embodiments, a reaction occurs upon mixing. However, in others, the composition comprises a substantially unreacted mixture of the components.

After mixing, the hydrophobic surface treatment composition can be applied to a surface, such as, but not limited to glass, plastics, metal, and wood. In particular embodiments, the hydrophobic surface treatment composition is applied to a glass or plastic window, such as a windshield of a motorized vehicle. The hydrophobic surface treatment composition may be applied by any suitable method, including wiping or spraying the composition onto the surface. A condensation reaction between the functional groups of the silicone fluid and the hydroxyl or hydrolyzable groups of the substrate bonds the hydrophobic surface treatment composition to the substrate. After being applied to the surface, the composition is allowed to dry, thereby forming a film. In some embodiments, the composition is allowed to dry on the surface at atmospheric conditions. In other embodiments, a heat source may be used to dry the composition after it has been applied to the surface. In some embodiments, the components of the composition are transformed by a chemical reaction during either the mixing or the drying stages. In other embodiments, the components of the composition remain substantially unreacted during the mixing and drying stages. Thus, the components initially used in preparing the hydrophobic surface treatment composition may or may not be present in the film as it exists on the treated surface.

After drying, the composition forms a transparent, hydrophobic film on the surface. The hydrophobicity of the treated surface is determined by measuring the contact angle of water droplets on the surface according to ASTM D 5725-99. Generally, reagent water is used in such measurements. Suitable stroke lengths depend on the film composition and can be determined according to Procedure A of ASTM 5725-99. Generally, stroke lengths of from about 0.6 mm to about 2 mm are suitable. Where a surface is tested with more than one drop, the individual drops are separated by at least about 2 cm. In some embodiments, the average contact angles for films formed from the compositions described herein range from about 80° to greater than about 1050. In some embodiments, the contact angle is greater than about 85°, 90°, 95°, or 100°. The deviation of the samples from the average is generally about 10%. A higher contact angle is generally indicative of increased hydrophobicity of the film.

The films preferably have a relatively high abrasion resistance when applied to a surface. Preferably, films are durable enough to withstand repeated abrasions of typical automobile windshield wipers. Abrasion resistance was measured by a modification of ASTM D-2486 using an AG-8100 Byk-Gardener Abrasion Tester with a reciprocating linear motion at 37.0+1 cycles per minute with a constant speed over a 10 inch travel. The drive mechanism of the abrasion testing apparatus consists of a gearhead motor driving the motor drive pulley gear. The rotary motion of this gear drives a smaller gear, the chain drive pulley, using a timing belt. The smaller gear drives a set of sprockets and continuous loop mechanism. The cable pair ends are attached to the virtual center of the chain, transforming the rotary motion of the chain into the reciprocating linear motion. Glass substrates were cut to fit the sample holder and treated with the compositions disclosed herein. An ordinary windshield wiper blade was attached to the apparatus to contact the glass at a wiper tension or pressure on the surface of approximately 1.5 oz/inch and operated in a manner simulating actual wiper operation. In operation, one back and forth motion of the wiper blade is considered a “wiper cycle.” The contact angle of water droplets was measured at various stages of the abrasion testing.

### EXAMPLES

The following examples are given to illustrate various embodiments of the invention. They do not intend to limit the invention as otherwise described and claimed herein. All numerical values are approximate. When a numerical range is given, it should be understood that embodiments outside the range are still within the scope of the invention unless otherwise indicated. In the following examples, various compositions were characterized by a number of methods. Performance data of these compositions were also obtained. Most of the methods or tests were performed in accordance with an ASTM standard, if applicable, or known procedures.

### Example 1

A hydrophobic surface treatment composition was prepared having about 5.0 percent by weight of a polysiloxane that had a viscosity of about 10 cps at 25° C., about 78 percent by weight of ethanol and about 16 percent by weight of isopropyl alcohol. Acetic acid was added as the catalyst in an amount of about 1.0 percent by weight. The composition was applied to a glass surface and the contact angle of water drop on the surface was 95°.

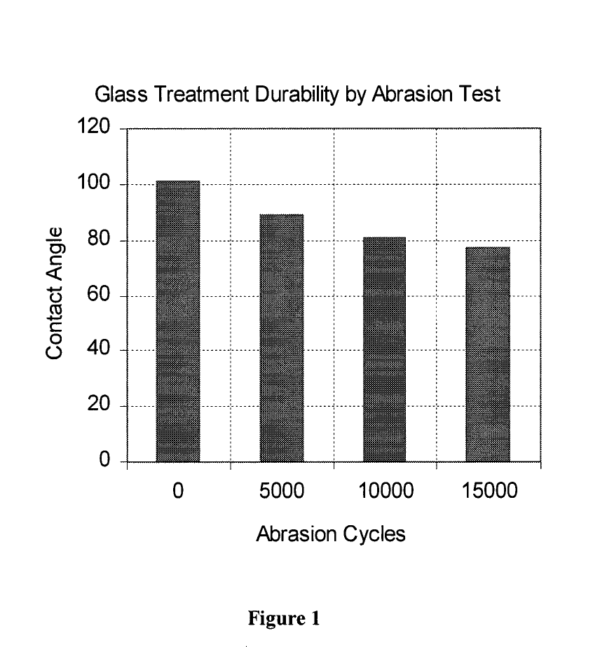

The above composition's abrasion resistance was measured using the above abrasion test method. FIG. 1 shows the contact angle as a function of wiper cycles. Preferably, the compositions withstand at least about 1,000, about 5,000, or about 10,000 wiper cycles before the contact angle of water droplets on the surface falls below 60°. In some embodiments, the compositions form a film that is durable enough to withstand more than about 15,000 or more than about 20,000 wiper cycles after which the contact angle of water on the surface of the glass remains at least about 60°. In other embodiments, the contact angle of droplets remains about 65°, about 70°, about 75°. In still other embodiments, the contact angle remains about 800, about 85°, or about 90° after about 5,000, about 10,000, about 15,000, about 20,000 or more wiper cycles.

### Example 2

A hydrophobic surface treatment composition was prepared having about 8.5 percent by weight of a polysiloxane that had a viscosity of about 50 cps at 25° C., about 80.0 percent by weight of ethylene glycol monobutyl ether and about 11.0 percent by weight of hydrocarbon solvent (boiling point ˜260° F.). Sulfuric acid was added as the catalyst in an amount of about 0.5 percent by weight. The composition was applied to a glass surface and the contact angle of water drop on the surface was 104°.

### Example 3

A hydrophobic surface treatment composition was prepared having about 2.0 percent by weight of a methoxy functionalized polysiloxane that had a viscosity of about 20 cps at 25° C., about 97.4 percent by weight of a hydrocarbon solvent (boiling point ˜320° F.) and about 0.6 percent by weight of acetic acid. The composition was applied to a glass surface and the contact angle of water drop on the surface was 100°.

### Example 4

A hydrophobic surface treatment composition was prepared by combining about 0.8 percent by weight of a perfluoroalkyl trichlorosilane with about 99.2 percent by weight of a hydrocarbon solvent (boiling point ˜300° F.) and about 16 percent by weight of isopropyl alcohol. Acetic acid was added as the catalyst in an amount of about 1.0 percent by weight. The composition was applied to a glass surface and the contact angle of water drop on the surface was 103°.

### Example 5

100 g of amino-functional polydimethylsiloxane having a viscosity 20 cps at 25° C. and 1.5 milliequivalents of base per gram of fluid is mixed with 32 grams of 1,2-epoxytetradecane and reacted at 50° C. for 3 days.

### Example 6

A hydrophobic surface treatment composition was prepared by combining about 1% by weight of the composition of Example 5 with about 93.9% by weight isopropyl alcohol, about 5% by weight ethylene glycol monobutyl ether, and about 0.1% by weight of stannous octoate. The hydrophobic composition of Example 5 is then applied to a clean glass plate. The water contact angle of the treated surface is measured 3 hours later after the application to yield a value of 103°.

The compositions described above provide a convenient source for forming a protective hydrophobic coating that is suitable for application to any number of articles. Moreover, these compositions are easy to apply. While the compositions may be applied to articles and surfaces by spraying, via aerosol or other pressurized or pump type containers, such complicated application means are not necessary. Unlike some other hydrophobic compositions, the compositions described herein may simply be applied with a cloth or other suitable applicator.

While the invention has been described with respect to a limited number of embodiments, the specific features of one embodiment should not be attributed to other embodiments of the invention. No single embodiment is representative of all aspects of the inventions. In some embodiments, the compositions may include numerous compounds not mentioned herein. In other embodiments, the compositions do not include, or are substantially free of, any compounds not enumerated herein. Moreover, variations and modifications therefrom exist. For example, various additives may also be used to further enhance one or more properties of the compositions and films made therefrom. It should also be understood that uses of the compositions are not limited to surface treatments, thus any product benefiting from a hydrophobic composition may be made. Therefore, articles wherein the composition is absorbed into the article or wherein the article is fabricated in a manner to incorporate the compositions described herein are envisioned. While the processes herein are described as comprising one or more steps, it should be understood that these steps may be practiced in any order or sequence unless otherwise indicated. These steps may be combined or separated. Finally, any number disclosed herein should be construed to mean approximate, regardless of whether the word “about” or “approximate” is used in describing the number. The appended claims intend to cover all such variations and modifications as falling within the scope of the invention.

What is claimed is:

1. A treated article comprising:
a. a substrate, and
b. a hydrophobic film coated to the surface of the substrate, the film is obtainable from a hydrophobic surface treatment composition comprising a mixture or reaction product of:
i. a silicone fluid; and
ii. a solvent
wherein the silicone fluid is an alkyl silane or a polysiloxane following the formula: 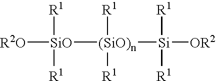
wherein each R¹ and R² is individually selected from the group consisting of hydrogen and substituted or unsubstituted, saturated or unsaturated, alkyl or aryl groups having 1 to 40 carbon atoms, and wherein n ranges from greater than 0 to about 150
wherein at least one of R¹ and R² comprises a functional group capable of a condensation reaction with hydroxyl.

2. A method of manufacturing a treated surface, comprising:
a. applying a hydrophobic surface treatment composition to a surface of a substrate, the surface having hydroxyl groups attached thereon, the hydrophobic surface treatment composition comprising:
i. a silicone fluid; and
ii. a solvent
wherein the silicone fluid is an alkyl silane or a polysiloxane following the formula: 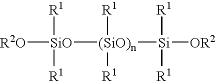
wherein each R¹ and R² is individually selected from the group consisting of hydrogen and substituted or unsubstituted, saturated or unsaturated, alkyl or aryl hydrocarbyl groups having 1 to 40 carbon atoms, and wherein n ranges from greater than 0 to about 150
wherein at least one of R¹ and R² comprises a functional group capable of a condensation reaction with the hydroxyl groups of the substrate.

3. In claim 1 or 2, wherein the hydrophobic surface treatment composition is substantially free of an external curing agent.

4. In claim 1 or 2, wherein the hydrophobic film composition further comprises a cosolvent.

5. In claim 1 or 2, wherein the hydrophobic film composition further comprises a catalyst.

6. In claim 1 or 2, wherein the hydrophobic film composition further comprises a cosolvent and a catalyst.

7. In claim 1 or 2, wherein the hydrocarbyl group is selected from the group consisting of methyl, ethyl, propyl, vinyl allyl, and phenyl groups.

8. In claim 1 or 2, wherein the hydrocarbyl group is a hydrolyzable functional group.

9. In claim 8, wherein the hydrolyzable functional group comprises an alkoxy group having 1-40 carbon atoms.

10. In claim 1 or 2, wherein the hydrophobic film composition further comprises a compound selected from the group consisting of epoxides, isocyanates, and fatty acid derivatives thereof, wherein R includes an amino group.

11. In claim 1 or 2, wherein the hydrocarbyl group is substituted with a halide selected from the group consisting of fluoride, chloride, bromide, and iodide

12. In claim 1 or 2, wherein the solvent is includes alkyl or aryl, substituted or unsubstituted alcohols, ethers, esters, or hydrocarbons having between 1 and 40 carbon atoms and water.

13. In claim 4, wherein the cosolvent is selected from the group consisting of alkyl or aryl, substituted or unsubstituted alcohols, ethers, esters, or hydrocarbons having between 1 and 40 carbon atoms and water.

14. In claim 6, wherein the cosolvent is selected from the group consisting of alkyl or aryl, substituted or unsubstituted alcohols, ethers, esters, or hydrocarbons having between 1 and 40 carbon atoms and water.

15. In claim 5, wherein the catalyst is an acid or a metal salt of an organic acid.

16. In claim 6, wherein the catalyst is an acid or a metal salt of an organic acid.

17. In claim 15, wherein the acid is selected from the group consisting of acetic acid, sulfuric acid, nitric acid, phosphoric acid, and hydrochloric acid.

18. In claim 16, wherein the acid is selected from the group consisting of acetic acid, sulfuric acid, nitric acid, phosphoric acid, and hydrochloric acid.

19. In claim 15, wherein the metal is selected from any element of Groups IIB, IIIB, IVB, IIIA, and IVA of the Periodic Table of Elements.

20. In claim 16, wherein the metal is selected from any element of Groups IIB, IIIB, IVB, IIIA, and IVA of the Periodic Table of Elements.

21. In claim 1 or 2, wherein the treated surface has a contact angle ranging from about 80° to greater than about 105°.

22. In claim 1 or 2, wherein the treated surface has a contact angle greater than about 85°.

23. In claim 1 or 2, wherein the treated surface has a contact angle greater than about 900.

24. In claim 1 or 2, wherein the treated surface has a contact angle greater than about 95°.

25. In claim 1 or 2, wherein the substrate is selected from the group consisting of glass, metal, wood, and polymers.

26. In claim 2, wherein drying is effected by evaporation at ambient temperature.

27. In claim 2, wherein drying is effected by heating.

28. In claim 1 or 2, wherein after more than about 1,000 wiper cycles the treated surface has a contact angle greater than about 60°.

29. In claim 1 or 2, wherein after more than about 5,000 wiper cycles the treated surface has a contact angle greater than about 60°.

30. In claim 1 or 2, wherein after more than about 10,000 wiper cycles the treated surface has a contact angle greater than about 60°.

31. In claim 1 or 2, wherein after more than about 15,000 wiper cycles the treated surface has a contact angle greater than about 60°.

32. In claim 1 or 2, wherein after more than about 20,000 wiper cycles the treated surface has a contact angle greater than about 60°.
